(19) United States
(12) Patent Application Publication
(10) Pub. No.: US 2010/0264642 A1
(43) Pub. Date: Oct. 21, 2010

(54) SECURITY SHEET COMPRISING A FIBER SUBSTRATE INCLUDING AT LEAST ONE WATERMARK

(75) Inventors: Henri Rosset, Le Pin (FR); Michel Camus, Rives Sur Fure (FR); Stephane Mallol, Provins (FR)

Correspondence Address: OLIFF & BERRIDGE, PLC, P.O. BOX 320850, ALEXANDRIA, VA, 22320-4850, US

(73) Assignee: Arjowiggins Security, Paris (FR)

(21) Appl. No.: 12/746,838

(22) PCT Filed: Dec. 16, 2008
(86) PCT No.: PCT/FR08/52308

§ 371 Date: Jun. 30, 2010

(30) Foreign Application Priority Data
Dec. 21, 2007 (FR) 0760218

(51) Int. Cl. B42D 15/00

(52) U.S. Cl. 283/70; 283/113

(57) ABSTRACT

A sheet including a fiber substrate including at least one watermark and having at least partially incorporated therein a ribbon that is narrower than the substrate and that overlies the watermark in part.

The present invention relates to the field of security documents. It relates to a security sheet, e.g. made mostly of paper, including at least one watermark and a security ribbon, and it also relates to a method of fabricating and a method of authenticating such a security sheet.

In the description, “paper” is used to mean any sheet obtained by a wet technique from a suspension of natural cellulose fibers, and/or mineral fibers, or organic fibers other than cellulose fibers, possibly synthetic fibers, and possibly containing various fillers and various additives commonly used in papermaking.

The terms “recognition”, “authentication”, and “identification” are defined herein as follows: “recognition” applies when a document or an element of a document is compared with a reference in order to determine the authenticity of the document or the element; “authentication” corresponds to the fact of determining whether the document is authentic or has been falsified or counterfeited; and “identification” corresponds to verifying the identity of the owner of a given document.

The terms “ribbon” and “thread” are synonymous, the term “thread” nevertheless preferably being reserved to a ribbon of small width. The term “strip” and “ribbon” are also sometimes used for designating the same article.

Security documents may be bank notes, identity cards, passports, driver's licenses, visas, checks, certificates for securities, tickets for transport, or tickets for entry to a cultural or sporting event, amongst others.

### Authenticating a Security Substrate in the Prior Art

Among known methods of authenticating security documents there are numerous methods that involve one or more security elements in strip form placed on the security document or a watermark on the security document.

Application EP 0 773 320 in the name of the Applicant describes a security sheet including a watermark and a strip juxtaposed with the watermark or totally covering the watermark, the strip and the watermark co-operating together so that the sheet conserves thickness that is substantially constant.

Application WO 2007/090999 in the name of the Applicant describes a sheet material comprising two fiber layers of different colors that overlie each other completely.

### Security Element(s) in Strip Form

When fabricating a security sheet having one or more security elements in strip form, there are two main ways of obtaining strips that contain security elements: either small security elements are introduced, e.g. elements such as flakes, which are elements made of plastics material and/or paper, which are flat and of relatively small format, or elements such as fibers that are colored or luminescent; or else a fine ribbon, commonly referred to as a “security thread”, is introduced. The ribbon is generally made of plastics material and includes security elements, e.g. luminescent elements.

Relatively small format security elements such as fibers or flakes may be introduced into the strip, if the papermaking machine is a flat bed (Foudrinier) machine, by a laminar stream of a jet containing a suspension of security elements that is passed over a sheet of paper while it is being formed, which paper is subsequently pressed and then dried using the usual papermaking method. That introduction technique is described for example in patent application EP 1 253 241.

When using a papermaking machine having a cylinder mold, security elements may be introduced in strip form in particular by feed ducts that are placed along the width of the paper and that open out into the vat containing the mold in the proximity of the cylinder mold, prior to beginning to drain the fiber suspension on the wire of the cylinder mold. After draining, a security sheet is obtained that is subsequently pressed and then dried using the usual papermaking method.

The main drawback relating to the first technique for obtaining a strip containing security elements is the irregular dispersion of the security elements. Because of the way the elements are introduced, it is difficult to obtain a strip having edges that are regular and within which the distribution of the security elements is regularly uniform, not only across the width (x) and along the length (y), but also through the thickness (z) of the security sheet.

These variations in the width of the strip and in the three-dimensional distribution (x,y,z) of the security elements may be troublesome for recognition and/or authentication and/or identification based on the three-dimensional distribution (x,y,z) of the security elements in the security document. Because of excessive variability, it may be impossible to use the position or the width of the strip, or even the three-dimensional distribution of the security elements, for recognition and/or authentication and/or identification purposes.

The type of problem mentioned above is to be found in particular when authenticating security elements automatically by using a portable device that relies on the signal specific to one or more security elements. Certain security elements are covered by a layer of fibers and/or mineral fillers that is too thick to allow their specific signals to be detected properly by the automatic authentication device. Thus, for a signal having a given intensity, it is necessary to introduce a larger quantity of security elements in order to compensate for the loss of signal intensity.

In the second technique for obtaining a strip containing security elements, the security threads that are introduced generally present a width of less than 10 millimeters (mm), and a thickness lying in the range 12 micrometers (μm) to 45 μm, and in most circumstances they are constituted by ribbons of plastics materials, in particular those based on polyester.

Security threads are made secure in particular by optionally visible patterns that may be positive and/or negative, optically variable devices and in particular holograms, luminescence and in particular fluorescence, magnetism, electrical conduction, or indeed thermochromic behavior.

Security threads are incorporated within the fiber substrate constituting the security sheet either “embedded”, i.e. completely covered in fiber material, or else “windowed”, the security thread then being situated on the surface of the security sheet and being embedded therein, e.g. in alternation. In particular, windows as described in this way may optionally be through windows, depending on whether the security thread appears on both faces or on only one of the faces of the security sheet.

Introducing embedded security threads may be performed in a single ply on a Foudrinier or a cylinder mold papermaking machine. With a cylinder mold machine, the thread is introduced into the vat before or very shortly after the beginning of draining the fiber suspension on the wire. The position of the security thread in the thickness of the final security sheet is determined in particular by the location at which the security thread is introduced and by its angle of inclination. The resulting ply can then be united while wet, i.e. before it is dried, with other plies having fiber compositions that may be identical or different and that may be formed on Foudrinier or cylinder mold papermaking machines.

Another way of introducing embedded security threads is to incorporate them between two successive plies produced on a Foudrinier and/or a cylinder mold machine, prior to uniting successive plies by pressing them together while wet. The plies may themselves be united with other plies of compositions that may be identical or different, and that may be formed on a Foudrinier or a cylinder mold machine, before or after the security threads are introduced. After the two successive plies including the security threads have been united, they are optionally united with other plies and subsequently dried using the usual papermaking method so as to obtain a security sheet.

A security thread may be windowed in a single ply in the manner described in patent application EP 0 059 056 for a cylinder mold papermaking machine or in EP 0 609 252 for a Foudrinier papermaking machine, for example. Windowing between two plies of multi-ply fiber material is described in patent application EP 0 229 645.

In order to improve their adhesion with the fiber substrate, security threads may in particular be coated in an adhesive, e.g. heat-sealing compositions or indeed compositions suitable for heat reactivation.

Introducing security threads may give rise in particular to security threads being poorly covered giving rise, when they are embedded, to a lack of material over the security threads, and when they are windowed, to insufficient bridging. The term “bridging” is used to designate the fiber covering of a windowed security thread in zones that lie between the windows, i.e. in locations where the thread is embedded in the material of the security sheet. Such a lack of fiber material on a security thread is commonly referred to as the “sparkling effect”. It can be particularly marked when the security sheet in which the security threads are introduced is of light weight.

The sparkling effect gives rise in particular to visible defects in the security sheet and to the security sheet being weakened, thus constituting a drawback for prior art security sheets that contain security threads.

In addition, incorporating security threads of width that exceeds about 1.5 centimeters (cm), regardless of whether they are embedded or windowed, is difficult since they lead to the fiber sheet rupturing in the wet portion of the papermaking machine, i.e. before the sheet of paper is dried. Furthermore, the further upstream ruptures occur in the sheet on the papermaking machine, the more they are troublesome, firstly because the path to be followed to bring the sheet up to the winder is longer, and secondly because the path is more difficult to follow because the sheet is less dry and is therefore weaker. Rupture of the sheet in the wet portion is thus more troublesome than rupture while it is drying insofar as a greater length of time is required for cleaning, restarting, and getting production under way.

Such ruptures may occur in particular as a result of the security threads being poorly covered or as a result of insufficient bridging as mentioned above. The greater the width of the security threads, the more such defects are marked. This makes the sheet correspondingly weaker, in particular along the strip where the security threads are introduced, and consequently increases the frequency of sheet rupture.

Furthermore, adhesives of the kind that may be added to security threads, such as heat-sealing coatings, do not develop their adhesive properties until after the sheet of paper containing the security threads has dried, and since the plastics materials constituting security threads are hydrophobic, prior art security threads do not develop any bonding with the fiber structure of the security sheet during the draining and the pressing that takes place in the wet portion, i.e. before the sheet is dried. Consequently, introducing security threads weakens the security sheet along the strips where security threads are introduced, since the adhesive properties of an adhesive-coated security thread, e.g. coated in a heat-sealing composition, do not develop until the sheet is dry.

Furthermore, if security threads are too wide, their impermeability impedes draining the water contained in the fibers situated above the threads, thus preventing the fiber mat from consolidating, and thereby giving rise in particular to ruptures in the sheet of paper in the wet portion, during the production of security sheets that contain security threads. When the width of security threads exceeds about 1.5 cm, the fiber mat is no longer sufficiently strong and gives rise to too great a number of paper sheet ruptures to enable the papermaking machine to operate properly.

Because of the technical problems set out in the above paragraph, security threads suffer in particular from the drawback of being of limited width.

The materials from which security threads are made are generally plastics films that are optionally metallized, and then possibly covered in varnish.

Another drawback of security threads is that they can be combined only with particles that are very fine, and in particular by printing and/or metallizing. By way of example, it is not possible to incorporate flat security elements of relatively small format, such as flakes, because of the materials from which security threads are made.

### Watermarks

A security document may also be authenticated by using at least one watermark.

The use of a watermark adds a security element for authenticating a security document is described on many occasions in prior art publications.

The presence of a watermark seeks to make it impossible to copy a document by optical means such as a photocopying, photography, or scanning, because the medium on which the copy is made does not include the watermark of the original document.

When a security sheet is for use in making a security document, watermarks are conventionally obtained by an operation of molding or embossing the wet sheet obtained from the aqueous suspension of cellulose fibers during fabrication of the paper. At this stage of fabrication, the cellulose fibers migrate easily in the aqueous suspension so the above-mentioned operation has the effect of increasing the concentration of fibers in the thicker zones of the sheet and of decreasing their concentration in the thinner zones, with the result obtained after the paper has dried being that the paper, when viewed in transmitted light, includes pale zones that are poor in fibers and dark zones with a high density of fibers.

The pale zones may be referred to as zones of low optical density, less than that of the vellum, i.e. the zone of the paper without a watermark, and the dark zones may be referred to as zones of optical density that is high, greater than that of the vellum.

### SUMMARY

The mere presence of a security thread or strip within a security document is sometimes not sufficient to guarantee authenticity.

Consequently, there exists a need to further improve the security of security sheets against attempted counterfeiting.

The invention seeks to satisfy this need, in particular by providing additional security obtained by a particular association of a watermark with a security ribbon.

To this end, the invention provides a sheet comprising a fiber substrate including at least one watermark and having at least partially incorporated therein a ribbon that is narrower than the substrate and that overlies the watermark in part.

Advantageously, the association of the watermark of the fiber substrate and the ribbon partially overlying the watermark makes it possible to obtain specific effects that are visible to the naked eye by observing in transmitted light or in reflected light, and that are difficult or even impossible to reproduce by printing.

Thus, it is possible to obtain different levels of protection for the security document including a sheet of the invention, because of the security due to the watermark, the security due to the ribbon, which may possibly include additional security elements, and the security linked to the association of the ribbon with the watermark.

In addition, the security due to the presence of the watermark appears differently depending on whether the watermark does or does not overlie the ribbon. This contributes to increasing the difficulties faced by counterfeiters.

The invention also provides a method of authenticating a sheet of the invention, the method consists in observing the sheet, in particular in transmitted light and in reaching a conclusion about its authenticity at least as a function of a difference of appearance between a region of the watermark that does not overlie the ribbon and a region that does overlie the ribbon, in particular a color difference.

### Ribbon

The term “ribbon” designates a ribbon made as a single piece or made as an assembly, a stack, or a juxtaposition of individual strips.

The ribbon may be completely incorporated in the fiber substrate, e.g. by being embedded within one ply or between two plies. This may make it difficult for a counterfeiter to detect its presence.

The ribbon may be incorporated in part only in the fiber substrate, e.g. by being windowed therein. It is thus possible to observe the ribbon on its own and/or the ribbon overlying the watermark in one or more windows of the security sheet.

The ribbon may optionally be combined with a strip of thermoplastic and/or metallic material, e.g. polyethylene terephthalate (PET) pasted or hot-laminated onto the ribbon before it is introduced into the fiber substrate.

Incorporating the ribbon in the substrate need not give rise to extra thickness for the security sheet. For example, the ribbon may be introduced in the fiber substrate using the method described in application EP 0 773 320.

The ribbon need not have any watermark. In a variant, the ribbon may include at least one watermark. Under such circumstances, the watermark of the fiber substrate overlying the watermark of the ribbon may make it possible to observe a pattern that results from the association of the watermarks.

The watermark of the ribbon may also be juxtaposed with the watermark of the substrate so that their juxtaposition creates a new pattern.

The ribbon may present optical properties that are different from those of the substrate, in particular color, fluorescence, phosphorescence, magneto-optical, photochromic, thermochromic, piezochromic, or iridescence properties, amongst others.

For example, the substrate and the ribbon may have different colors. Any color is possible. The ribbon and the substrate may present a color difference or colorimetric difference ΔE that is greater than 0.2, and preferably greater than 1. Nevertheless, the human eye is more sensitive to a color difference on hues that are not saturated, and the person skilled in the art may adapt the color difference so as to obtain the desired “contrast”.

The ribbon may include a conventional ink or a security ink, in particular an ink that is fluorescent, phosphorescent, magnetic, photochromic, thermochromic, piezochromic, or iridescent, amongst others. The ink may be applied over the ribbon in part or in full, i.e. on only certain zones of the surface of the ribbon or over the entire surface of the ribbon. The ink may be applied to the ribbon by print means, such as for example offset, photogravure, silkscreen, or ink-jet printing.

The ribbon may also be coated in a varnish that may be transparent or colored.

The ribbon may include a fluorescent agent. The fluorescent agent may optionally be colored, and it may be visible or invisible in visible light. By way of example, the fluorescent agent may be incorporated in the material of the ribbon. The fluorescent agent may be visible under light that is ultraviolet (UV) and/or infrared (IR), for example.

Preferably, the ribbon extends between two opposite sides of the sheet.

The ribbon may present sides of irregular shape, e.g. in the form of broken or undulating lines, or crenellations, or a zigzag, amongst others. The edges of the ribbon may both have the same shape or they may have different shapes, they may be regular or they may be irregular.

The ribbon may also present various characteristics that are perceptible to sight or to touch, for example.

By way of example, the ribbon may be embossed, thus making it possible to create a particular effect, e.g. a tactile or surface relief effect, it being possible for the ribbon to appear in part on the surface of the fiber substrate.

The ribbon may be coated in a thermoplastic polymer and may optionally be embossed after being coated in this way.

The ribbon may be printed using drops of varnish, of resin, or of heat-swelling ink, amongst others.

When the ribbon includes printing, that may make it possible for example to obtain variable optical effects.

The ribbon may include a heat-swelling ink that enables at least one portion in relief to be created, said ink being activated prior to introducing the ribbon into the fiber substrate. Activation prior to incorporation serves to reduce the risk of the sheet being deconstructed while the ink is swelling.

The ribbon may include particles, for example detectable by the naked eye or to the touch, which particles may be incorporated in the material of the ribbon, e.g. in the form of beads, e.g. beads of synthetic material, e.g. of polyurethane, or of mineral material, e.g. glass, and of a size that is less than 300 μm, for example, or by being deposited by silkscreen printing or by photogravure, e.g. in the form of beads having a size of less than 100 μm, for example.

The ribbon may include a textile strip, e.g. a knitted strip, that is incorporated in the ribbon or that is pasted to the ribbon.

The ribbon may include printing in relief, e.g. by silkscreen printing.

The ribbon may present a feel that is fatty, rough, smooth, silky, soft, amongst others.

The ribbon may, in particular, include deposits of polymers, in particular in the form of beads, e.g. beads of polyurethane (PU), beads of glass, of polyamide 6 or polyamide 12, of styrene-acrylic pigment, of wax, or beads of polypropylene (PP), of polyethylene (PE), of polyvinyl chloride (PVC), of polymers based on methyl methacrylate, the ribbon being incorporated by being windowed, for example.

The ribbon advantageously maintains its own cohesion after being introduced into the fiber substrate. Thus, after the ribbon has been introduced into the fiber substrate, its structure may be observable under certain conditions, e.g. in section or by viewing in reflection or in transmission. Thus, it may be possible to observe the ribbon by differences in optical properties, e.g. differences in contrast, in color, in saturation, in clarity, in opaqueness, that reveal a frontier between the ribbon and the substrate or that characterize the presence of the ribbon.

The ribbon may also be observable in the sheet by topography.

Where appropriate, the ribbon may also be observable by transparency in the sheet, in particular to the naked eye.

In order to obtain the ribbon, it is possible for example to fabricate a fiber sheet, e.g. of low weight, e.g. lying in the range about 15 grams per square meter (g/m²) to 90 g/m², using an ordinary papermaking method, i.e., for example, by draining a suspension of fibers optionally including fillers and additives that are conventional in papermaking, together with the optional specific security elements, pressing the resulting fiber mat, and then drying it. The sheet may subsequently optionally be calendared, thereby making it possible in particular to reduce its thickness, and it is then cut so as to form ribbons that are wound in reels.

By way of example, the ribbon may be based on cellulose fibers (in particular on cotton fibers) and/or on natural organic fibers other than cellulose fibers, and/or synthetic fibers, e.g. such as fibers of polyester or polyamide, and/or optionally mineral fibers, e.g. such as glass fibers. The ribbon need not include fibers of polyvinyl alcohol (PVA).

The fibers may be hydrophilic, in particular so as to develop chemical bonds with the fiber substrate, in particular hydrogen bonds.

The ribbon may comprise at least 50% by weight of cellulose fibers.

The ribbon may present a weight lying in the range 5 g/m² to 100 g/m², preferably lying in the range 15 g/m² to 55 g/m², and more preferably in the range 20 g/m² to 30 g/m².

In a particular embodiment of the invention, the ribbon is of width lying in the range 2 mm to 60 mm, preferably in the range 4 mm to 30 mm, and more preferably in the range 10 mm to 20 mm.

The ribbon may include perforations, in particular in order to encourage draining while the sheet is being fabricated, or indeed to add an additional optical effect, in particular in combination with at least one watermark. For example, the perforations may be disposed at the margin of said ribbon or in such a manner as to form a pattern or a code.

In an embodiment of the invention, the ribbon is of thickness lying in the range 10 μm to 150 μm, e.g. in the range 20 μm to 120 μm, preferably in the range 30 μm to 80 μm, and more preferably in the range 45 μm to 55 μm.

The ribbon may include a watermark and perforations around the watermark.

In a preferred embodiment of the invention, the ribbon may also include a security element.

The ribbon may include at least one security element on one of its faces, or on both of its faces. The ribbon may include different security elements on each of its faces.

The security element may be selected from tracers, in particular nanometric tracers; security fibers, in particular fibers that are metallic, magnetic (having soft and/or hard magnetism), or absorbent or excitable in the ultraviolet, the visible, or the infrared, and in particular in the near infrared (NIR); flat security elements of relatively small format such as flakes, pigments or clumps of pigments in particular pigments that are absorbent or excitable under laser illumination or in ultraviolet, visible, or infrared illumination, in particular in the near infrared; and security threads (based on plastics material, in particular on polyester) including in particular an at least partial coating that is metallic, metal-plated, iridescent, or magnetic (having soft and/or hard magnetism), the coating possibly including in particular positive or negative patterns and said patterns may in particular be obtained by removing metallization, chemical or biochemical reagents for combating falsification and/or for authentication and/or for identification, possibly being capable of reacting with at least one falsification and/or authentication and/or identification agent respectively; optically variable elements in particular holograms, liquid crystals, iridescent pigments, mirror-effect structures, in particular dielectric layers; and combinations thereof.

The incorporation of tracers in a security document by means of the ribbon is localized, thus making it possible in particular to create a zone, possibly a zone that is invisible to the naked eye, for recognizing and/or authenticating said security document. Recognition and/or authentication of said document may be based in particular on the intensity and/or the type of the signal generated by the tracers, considered individually or otherwise, on the density of the tracers, or indeed on their three-dimensional distribution in an optionally predefined zone of the document. In particular, tracers distributed in random manner may form a unique signature and may thus be used for identification purposes.

In particular, the introduction into the security sheet of pigments or clumps of pigments that are absorbent in the infrared or the near infrared, as mentioned above, may be used to make said sheet authentifiable, as described in patent application WO 2005/034049. That application recommends more particularly using kaolin and talc mixed together, substances that are in widespread use in the papermaking field, within a security sheet having a so-called variable distribution zone, and in particular a zone with a watermark. The use of such compositions makes it possible in particular to authenticate said security sheet by infrared spectroscopy, in particular in the near infrared, and improves optical reading of bar code watermarks. Nevertheless, the minimum quantity of such compositions that needs to be introduced into said sheet in order to enable it to be read optically and/or authenticated properly may be excessive compared with the maximum quantities of ash that are defined in certain specifications. The present invention thus enables the above problems to be solved, e.g. by providing a security sheet that includes a security ribbon having a watermark based on fiber material and a mixture of kaolin and talc at a concentration that is sufficient to encourage authentication by infrared spectroscopy of the document or by optical reading of the watermark. The concentration of kaolin and of talc will be particularly high, but only in the zone that contains the security ribbon, such that the security sheet that includes the security ribbon complies with upper limits on ash content that are laid down in specifications.

In the particular circumstance of a ribbon of the invention including magnetic fibers, an advantage of the invention relates for example to authenticating a security document by analyzing the signal of its magnetic response. In particular, by incorporating soft magnetic fibers by seeding, i.e. by mixing them in the fiber suspension prior to draining, it is possible to obtain reproducibly a uniform distribution of soft magnetic fibers. In contrast, introducing soft magnetic fibers in strip form as in the prior art, i.e. on a cylinder mold via localized feed ducts or by a laminar stream over a flat bed, gives rise to a degree of variability in the concentration of the soft magnetic fibers, and also to a degree of variability in the width of the strip of soft magnetic fibers. By using a security ribbon made by being cut from a sheet that includes soft magnetic fibers that were seeded therein, the invention makes it possible to reproducibly obtain a distribution of soft magnetic fibers that is uniform. Thus, by causing the concentration of soft magnetic fibers to vary and by varying the width of the resulting security ribbon, it is possible to increase the number of potential magnetic signals or “signatures”.

In a particular embodiment of the invention, the ribbon includes at least two security elements selected from those mentioned above.

In a particular embodiment of the invention, the ribbon includes 0.1% to 1% by dry weight of magnetic fibers, in particular soft magnetic fibers, relative to the total quantity of fibers, and it preferably includes 0.2% to 0.6%.

In a particular embodiment of the invention, the ribbon includes a plurality of flakes distributed with a density per unit area lying in the range 4000 to 25,000 flakes per square meter, preferably in the range 5000 to 20,000 flakes per square meter, and more preferably in the range 11,000 to 18,000 flakes per square meter.

In a particular embodiment of the invention, the ribbon comprises a series of parallel security threads, and more particularly the succession of inter-thread spaces and/or the series of security threads of different widths to constitute a code, in particular of the bar code type.

In a particular embodiment of the invention, the ribbon comprises a soft magnetic anti-theft thread.

This type of anti-theft security thread might be very sharp and therefore difficult to incorporate in a security sheet, and it may happen in particular that the anti-theft thread when introduced by a prior art method, i.e. directly in a fiber substrate, is not completely covered in fibers. Incorporating such an anti-theft security thread of the present invention consists in fabricating a fiber sheet in which a plurality of anti-theft security threads are introduced, with the security sheet as obtained in this way subsequently being cut into ribbons, each including at least one anti-theft thread. These ribbons are then introduced in the fiber substrate. Thus, zones of the ribbon that might present insufficient fiber covering are themselves covered by the fiber material of the fiber substrate, thereby obtaining a security sheet that includes at least one anti-theft security thread and that does not have any covering defects.

In a particular embodiment of the invention, the ribbon includes at least one electronic device. Preferably, the electronic device is a radiofrequency identification (RFID) device, and in particular an electronic chip and/or an antenna that may in particular be printed on the ribbon.

In a particular embodiment of the invention, the ribbon includes at least one chemical or biochemical reagent for combating falsification and/or for authentication and/or for identification that reacts in colored manner with at least one falsification and/or authentication and/or identification agent, respectively.

In particular, if the ribbon and the substrate are of the same color before said colored reaction, an improved authentication reaction is obtained since it reveals, in addition to coloring the ribbon, a difference in the appearance of the watermark between the watermark zone overlying the ribbon and the watermark zone that does not overlie the ribbon.

If the ribbon includes a chemical or biochemical authentication reagent that reacts in colored manner with at least one authentication agent, additional security is obtained for the security sheet containing the ribbon, with the authentication reaction being localized to the zone where the ribbon is incorporated.

Another advantage of the above embodiment is the ability to use at least one reagent for combating falsification in documents that are to receive surface treatment, in particular to enhance the adhesion of ink while documents are being personalized. Reagents of this type are generally not used since they are reagents that are incompatible with the mixtures of colloidal dispersions of polymers (latex) that are commonly used in making up surface treatments for paper, and by way of example mention may be made of the styrene-butadiene polymer latex sold under the name Latexia 301 by the supplier Ciba. Insofar as the ribbon is embedded, the invention thus makes it possible to incorporate these reagents in the ribbon and to apply at least one of the surface treatments to the fiber substrate without encountering this type of problem.

This particular embodiment has another advantage of enabling falsification-combating reagents to be used that react with certain adhesives, in particular those used for adhesive-coated sheets, in particular for visas for sticking on passports or for security films that are stuck onto certain security documents. The fact of incorporating the reagents in the ribbon serves to isolate the reagents and thus prevent any premature reaction between the reagents and the adhesives to be found in particular on adhesive-coated sheets, but without preventing reaction with the reagents that are used during attempts at falsifying security documents containing the adhesive-coated sheets.

Furthermore, in the field of security documents, a high degree of whiteness is sometimes required and that can be incompatible with using certain chemical or biochemical reagents for combating falsification and/or for authentication and/or for identification. Incorporating the ribbon thus makes it possible to introduce these reagents in certain zones of the document while preserving the overall whiteness of the document.

The ribbon may include perforations in a pattern or a code. Depending on the differences in opaqueness and in color between the substrate and the ribbon, the pattern or code may be observable, or observable in transmitted light only, or observable both in transmitted light and in reflected light. If the ribbon possesses fluorescent invisible printing, then the pattern may equally well be visible only under UV illumination.

In particular, the pattern provided by perforation includes at least one alphanumeric character or ideogram.

The ribbon may also include perforations in a pattern and further include a chemical or biochemical reagent for combating falsification and/or for authentication and/or for identification that reacts in a colored manner. During an attempt at falsification and/or while authenticating and/or identifying the document, the chemical or biochemical reagent reacts with the falsification and/or authentication and/or identification agent with a reaction that gives a particular color to the ribbon. The pattern made by perforation then becomes visible by contrast between the color of the ribbon and the color of the fiber substrate.

The ribbon may be calendared. The calendaring is performed in particular for the purpose of minimizing the extra thickness created by introducing the ribbon.

In a particular embodiment of the invention, the ribbon does not have a surface coating, for example it does not have a pigmented layer. This enhances good affinity between the fiber substrate and/or the ribbon.

In a particular embodiment of the invention, the ribbon presents wet strength (WS) in traction that is greater than 30%, in particular to avoid giving rise to problems on being introduced in the sheet. Wet strength in traction is measured by dividing the value of the wet strength in traction measured in application of the NF Q 03.056 standard by the dry strength in traction as measured in application of the NF EN ISO 1924 standard. This wet strength may be provided in conventional manner by adding a wet strength agent, e.g. such as a polyamine-amide-epichlorhydrin (PAAE) resin, a melamine formol resin, etc.

In a variant, additional wet strength may be obtained by adding some of the wet strength agent(s) into the surface-application baths of a fiber sheet, e.g. serving to fabricate the ribbon.

The ribbon may include an adhesive, e.g. a heat-sealing agent.

The ribbon may be fibrous, e.g. it may be a paper ribbon. Under such circumstances, the ribbon preferably includes an adhesive in order to improve its cohesion within the fiber substrate.

When the ribbon includes an adhesive, it may serve to optimize adhesion of the ribbon within the sheet.

By way of example, the adhesive may be a heat-sealing coating, e.g. a heat-sealing varnish, a UV curable agent, an adhesive for irradiating, a pressure-sensitive adhesive (PSA), a varnish with a solvent base, e.g. of the polyester type, an adhesive in the aqueous phase, etc. . . . .

As an adhesive in the aqueous phase, mention may be made in particular of the following trademarks: Mowilith DC (an aqueous dispersion of homopolymer vinyl acetate with particles of size lying in the range 0.3 μm to 2 μm and with a glass transition temperature T_{g} of about 38° C., having a solid matter dry content lying in the range 55% to 57%) and Vinamul 3265 from the supplier Celanase; DH9004, DH9017, DH9044, and DL5001 from the supplier Collano: Primal NW1845, Primal LC40, Primal P308M, and Primal EP6000 from the supplier Rohm & Haas; and 006SDW078-2 from the supplier Basf.

The adhesive may advantageously be an adhesive based on polyvinyl acetate, such as Mowilith DC.

The Applicant has observed that amongst the above-mentioned adhesives, Vinamul 3265, Mowilith DC, Collano DL5001, Primal NW1845, and Primal P308M give very good results in the dry crease test, i.e. the porosity of the paper is not excessively affected by creasing.

Furthermore, Vinamul 3265 and Mowilith DC also present very good results in the wet crease test. Mowilith DC presents very good results in the washing test.

Thus, Mowilith DC produces very good results in terms of adhesive power, but the invention is not limited to one particular adhesive.

In an embodiment of the invention, the adhesive is not present in the form of fibers, nor in the form of particles.

The adhesive may be added to the security ribbon in particular by a coating method, or by methods derived from printing a paper base after it has been fabricated, e.g. air-knife coating, photogravure, silkscreen printing, curtain coating, flexography, amongst others.

The adhesive may be coated, e.g. on a fiber sheet used for fabricating the ribbon, at a rate of 2 g/m² to 15 g/m² per face, and preferably at a rate of 3 g/m² to 8 g/m² per face, for example.

The sealing temperature may lie in the range 70° C. to 135° C., for example, depending on the adhesive used, and sealing may take place while the security sheet is drying.

Coating may be performed at least in part to the core, i.e. in depth, or may concern the entire ribbon or it may be on the surface.

Preferably, coating is performed on the medium used for fabricating the ribbon before said medium is cut up. In a variant, coating may be performed while fabricating the medium that is used for fabricating the ribbon.

Coating may be performed on a single face of the medium or on both faces thereof. The adhesive may completely cover the face on which it is deposited.

Adhesive may also be incorporated in the ribbon by impregnation, with the ribbon or the medium used for fabricating it being immersed in a bath.

In an embodiment of the invention, a fiber sheet weighing 20 g/m² that has been subjected to wet strength treatment is coated with an adhesive in aqueous phase at a rate of 5 g/m² per face, using a photogravure method, for example. This achieves a satisfactory compromise between adhesive power and the quantity of coated material.

In order to detect the presence of the adhesive in a security sheet of the invention, it is possible to observe the adhesive, e.g. the heat-sealing varnish, in the form of bubbles, e.g. with the help of a scanning electron microscope (SEM).

### Substrate

The term “substrate” is used to designate a fiber sheet possibly comprising one or more fiber layers. In particular, the term “ply” is used to designate layers that are produced continuously on a given papermaking machine and then associated while in the wet state.

The substrate may include one or more watermarks, presenting characteristics that are identical or different.

Preferably, the watermark carried by the fiber substrate is a pale watermark. Under such circumstances, the pale zones of the watermark present a mass per unit area that is strictly less than that of the vellum. In a variant, the watermark may be a dark watermark.

The watermark may also be a multi-tone effect watermark comprising a set of pale zones arranged to form a screened image presenting pale and dark tones. The screened image may include screened patterns, e.g. formed by lines. Patent application EP 1 122 360 discloses the making of such a watermark.

The substrate may include at least one security element, in particular selected from tracers, in particular nanometric tracers; security fibers, in particular fibers that are metallic, magnetic (having soft and/or hard magnetism), or absorbent or excitable in the ultraviolet, the visible, or the infrared, and in particular in the near infrared (NIR); flat security elements of relatively small format such as flakes, pigments or clumps of pigments in particular pigments that are absorbent or excitable under laser illumination or in ultraviolet, visible, or infrared illumination, in particular in the near infrared; and security threads (based on plastics material, in particular on polyester) including in particular an at least partial coating that is metallic, metal-plated, iridescent, or magnetic (having soft and/or hard magnetism), the coating possibly including in particular positive or negative patterns and said patterns may in particular be obtained by removing metallization, chemical or biochemical reagents for combating falsification and/or for authentication, and/or for identification, possibly being capable of reacting with at least one falsification and/or authentication and/or identification agent respectively; optically variable elements in particular holograms, liquid crystals, iridescent pigments, mirror-effect structures, in particular dielectric layers; and combinations thereof.

In particular, the fiber substrate may include security elements that are visible to the naked eye and it may also include tracers that are in the form of an active material, particles or fibers, that are capable of generating a specific signal when said tracers are subjected to excitation that may be optronic, electrical, magnetic, or electromagnetic. These tracers constitute a substance that is identifiable because of some distinctive property and that is used to mark an element (a security document in this example) and enable it to be traced, enabling its movements to be tracked, or enabling it to be recognized, authenticated, or identified.

Mirror-effect dielectric structures are constituted by alternating layers having low and high refractive indices, e.g. layers respectively of hafnium dioxide and of silicon dioxide, and in particular they may be obtained by ion etching.

In a particular embodiment of the invention, the fiber substrate includes at least one chemical or biochemical reagent for combating falsification and/or for authentication and/or for identification that reacts in colored manner, with at least one falsification and/or authentication and/or identification agent, respectively.

The fiber substrate may be made from fibers as described above for the ribbon.

In a particular embodiment of the invention, the fiber substrate and the ribbon are based on the same fibers, i.e. their fiber compositions are of the same kind and preferably in the same proportions, thereby providing good affinity between the two components and also possibly providing additional authentication means.

### Sheet

The sheet of the invention is preferably constituted by at least two plies and is formed by cylindrical mold papermaking, with the ribbon being positioned under one of the outer plies.

Furthermore, in the single-ply technique, introducing a ribbon in the sheet makes the paste difficult to drain, particularly when the ribbon is wide, whereas in the multi-ply technique, the ribbon is introduced after the plies have been formed. It is possible to envisage introducing a plurality of ribbons that are firstly spaced apart and secondly not too wide so as to avoid impeding draining.

It is also possible to envisage using a ribbon that is microperforated, at least in part, in order to facilitate draining and retention of the ribbon in the sheet.

It is preferable to use a sheet made on a cylinder mold since although it could be made on a flat-bed papermaking machine (a Foudrinier machine), watermarks on Foudrinier machines are formed with a watermarking roller or “Dandy roll” that gives less relief or depth to the watermark.

The sheet may also be formed on a papermaking machine combining both a flat bed and a cylinder mold, with the watermark being formed on the cylinder mold.

The ribbon may also be introduced into the fiber substrate by using the prior art techniques for introducing security threads made of plastics material or by pasting the ribbon between two fiber layers or sheets that then constitute the basis of the fiber substrate.

The security sheet proposed by the Applicant may in particular include at least one paper ribbon that may be wider than the prior art security threads but without presenting fiber coverage defects or insufficient bridging as described above. This results in particular from the permeability of paper ribbons that encourages drainage, and also the good affinity between the fibers of the paper security ribbon and the fiber material of the substrate.

In addition, the ribbons may be incorporated in the fiber substrate without increasing the frequency with which the sheet ruptures, in particular because of the preferred composition of paper security ribbons. The security ribbons preferably comprise hydrophilic fiber materials, in particular such as cellulose fibers or synthetic fibers or possibly mineral fibers that have been subjected to lubricating treatment, so as to develop bonds with the fiber substrate that serve to reduce substrate weakening due in particular to the introduction of an element in its fiber base. The lubricating treatment involves coating the fibers, in particular so as to make them hydrophilic.

Consequently, good cohesion can be obtained of the security sheet and it thus presents both good machineability in the wet portion and the ability to receive security elements in the form of strips that are relatively wide.

Associating the Substrate with One or More Ribbons

The substrate may incorporate one or more ribbons of the invention, with at least one of the ribbons partially overlying at least one watermark of the substrate.

Associating the ribbon and the watermark of the fiber substrate serves advantageously to create authentication means that rely on observing the zone where the ribbon and the substrate overlie each other and possibly also observing an adjacent zone.

Observing the watermark and the ribbon in the zone where they overlie each other may reveal variation in predefined optical properties that may serve to authenticate the document.

For example, the color observed in the zone where the watermark and the ribbon overlie each other may constitute a criterion for authenticating the document.

In a variant, authentication may consist in observing the watermark in zones where the ribbon and the watermark overlie each other and in zones where they do not overlie each other.

For example, differences in color and/or contrast as observed between zones where the watermark and the ribbon do or do not overlie each other, and in particular where these zones meet, may enable criteria to be defined for authenticating the document.

For example, it may be possible to observe continuity and matching between the patterns present in the watermark at the boundary between the zones where the watermark and the ribbon overlie each other and where they do not overlie each other.

In particular, the ribbon and the watermark may overlie each other in such a manner that portions of the watermark that do not overlie the ribbon exist on both sides of the ribbon. For example, the ribbon may cover the geometrical center of the watermark, and the width of the ribbon may be selected so as to allow the watermark to be observed on its own on both sides of the ribbon.

In a variant, the ribbon may be disposed relative to the watermark in such a manner that only one portion of the watermark that does not overlie the ribbon exists on only one side of the ribbon.

In a particular embodiment of the invention, each of the fiber substrate and the security ribbon includes at least one respective watermark, with the watermarks adding to each other by superposition and/or association.

In particular, the watermarks may overlie each other so as to obtain a moiré effect. Such an effect reveals a pattern that is produced in particular by lines coming close together when two watermarks having a periodic structure, and in particular a screened structure, overlie each other.

By way of example, the watermark may have a portion that extends continuously between two regions of the substrate that are respectively covered and not covered by the ribbon.

Authentication of the document results from observing the association of the ribbon with the watermark, and it is possible, for example, for the observation to be made with the naked eye, observing in reflection or in transmission, in visible light, in ultraviolet light, or in infrared light.

During observation, the color of a portion of the watermark situated in a region overlying the ribbon may be paler or darker than the color of a portion of the watermark situated in a region that does not overlie the ribbon.

The ribbon and the fiber substrate may each include at least one chemical or biochemical reagent for combating falsification and/or for authentication and/or for identification that reacts in colored manner with at least one falsification and/or authentication and/or identification agent, respectively. The chemical or biochemical reagents for combating falsification and/or for authentication and/or for identification are preferably different and may in particular react with a single agent or with two different agents.

In a particular embodiment of the invention, each of the ribbon and the fiber substrate of the sheet includes at least one chemical or biochemical reagent for combating falsification and/or for authentication and/or for identification, these reagents being chemically incompatible. The term “chemically incompatible” is used to mean that the reagents can react together because they are in contact with or because they involve chemical reactions with falsification or authentication and/or identification agents that are incompatible.

In the prior art, the use of a single fiber substrate sometimes makes it impossible to combine certain chemical or biochemical reagents for combating falsification and/or for authentication and/or for identification because said reagents on being inserted in a common substrate react together (incompatible reagents). In addition, the chemical or biochemical reagents for combating falsification and/or for authentication and/or for identification may be compatible but they may give rise to incompatible reactions during an attempt at falsification or authentication or identification of the security document that result in the document not being damaged while it is being falsified or in the authentication reaction not giving the expected result. The use of at least one ribbon of the invention thus has the particular advantage of enabling at least two incompatible reagents or reactions to be used, if so desired.

When the ribbon includes a chemical or biochemical reagent as defined above, it may be necessary to implement a prior chemical reaction in the ribbon, e.g. having the effect of modifying the optical properties of the ribbon, e.g. its color, so as to enable the document to be authenticated. Advantageously, authentication of the document cannot be performed without a prior chemical reaction modifying the optical properties of the ribbon.

### Security Document

The invention also provides a security document including a sheet as defined above.

The document may be fabricated by cutting out, associating, binding, laminating, gluing, and/or pasting the sheet.

More particularly, the security document may be payment means, such as a bank note, a check, or a meal ticket, an identity document such as an identity card or a visa or a passport or a driver's license, a lottery ticket, a transport ticket, or indeed an entry ticket to a cultural or sporting event.

### Article for Authenticating

The invention also provides an article for authenticating, the article including the sheet as defined or obtained above, the article being selected from a security label, packaging, in particular packaging for medication or for food or for cosmetics or perfumes or for electronic components or for spare parts, a sheet for use in the medical or hospital field, in particular a sheet for use in making sterilization packaging, or indeed art paper.

### Fabrication and Authentication Methods

The invention also provides a papermaking method of fabricating a sheet as defined above, in which method the ribbon based on fiber material is introduced into the fiber substrate in the wet portion. The assembly obtained in this way comprising the substrate and the ribbon is then pressed and dried.

In a particular embodiment of the invention, the ribbon is inserted in the wet portion being embedded or windowed in the fiber substrate. For this purpose, it is possible to use known methods of the prior art for introducing security threads made of plastics material. The ribbon may present any of the characteristics set out above, or any combination thereof.

In a particular embodiment of the invention, the method uses a papermaking machine that has at least one cylinder mold, and the ribbon is introduced in the vat containing the cylinder mold, before or shortly after the beginning of draining the composition forming the fiber substrate of the sheet.

In a particular embodiment of the invention, the method uses a papermaking machine that is fitted with at least one flat bed, and the ribbon is introduced above the flat bed, while the composition forming the substrate of the sheet is draining.

In a particular embodiment of the invention, the fiber substrate includes at least two plies, and the security ribbon is introduced prior to assembling two successive plies together in the wet state, i.e. in the usual papermaking method prior to drying the assembly comprising two fiber plies of the substrate.

In a particular embodiment of the invention, the ribbon as described above is incorporated between two fiber layers of the fiber substrate of the sheet by pasting.

In particular, the ribbon may appear in one or more windows, in particular if at least one of the layers includes perforations or zones that have no material.

The invention also provides a method of authenticating a sheet including a ribbon that includes at least one chemical or biochemical reagent for combating falsification and/or for authentication and/or for identification that react in colored manner with at least one falsification and/or authentication and/or identification agent respectively, and also perforations in a pattern or a code. In the absence of any application of the falsification or authentication agent, or before any such application, the chemical or biochemical reagent for combating falsification or for authentication and/or for identification does not react so the perforated pattern or code is invisible. When the sheet comes into the presence of a falsification or authentication and/or identification agent, the reaction between the reagent and the agent produces color in the ribbon, thereby making the perforated pattern or code legible.

The method is thus characterized in that the reaction between the reagent for combating falsification and/or for authentication and/or for identification and an agent respectively for falsification and/or authentication and/or identification imparts color to the ribbon making the perforations observable, in particular the perforated pattern or code, on the ribbon.

The invention can be better understood on reading the following description of non-limiting embodiments of the invention and on examining the accompanying figures, in which:

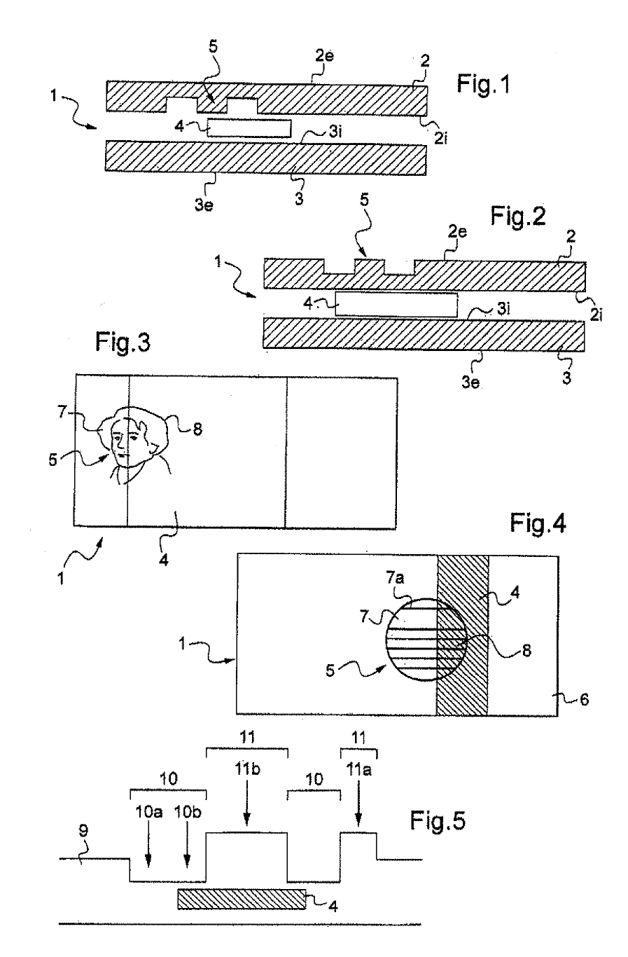

FIG. 1 is an exploded section view of a sheet of the invention, including a ribbon and a pale watermark;

FIG. 2 is an exploded perspective view of another embodiment of a sheet of the invention including a ribbon and a pale watermark;

FIG. 3 is a plan view of a sheet in an embodiment of the invention;

FIG. 4 is a plan view of another sheet in an embodiment of the invention; and

FIG. 5 shows an example of a sheet of the invention, in section.

FIG. 1 shows an embodiment of a sheet 1 of the invention. This sheet comprises a first ply 2 of paper and a second ply 3 of paper. The plies may be made in conventional manner on a flat-bed papermaking machine (a Foudrinier machine) or on a double cylinder mold machine.

At least one of the plies, specifically the first ply 2, includes a watermark 5. The watermark is a pale watermark, e.g. being made on a mold having the imprint of the watermark in relief. The pale watermark 5 may also be made using the method described in application EP 0 773 320.

The sheet 1 also includes a ribbon 4 that may be inserted between the two wet plies 2 and 3 under the watermark, prior to the plies being assembled together.

The ribbon 4 is a fiber ribbon and presents optical properties that are different from those of the substrate, e.g. having a color that is different from that of the substrate.

The first ply 2 has an inside face 2i and an outside face 2e. The term “inside face” designates the face that lies inside the finished sheet, i.e. after the plies 2 and 3 have been united. The term “outside face” designates the face that lies on the outside of the finished sheet.

The second ply 3 has an inside face 3i and an outside face 3e.

In the example described, the pale watermark 5 is made in the inside face 2i of the ply 2.

The ribbon 4 is positioned on the inside face 2i of the first ply 2, partially in register with the watermark 5.

In the variant of FIG. 2, the pale watermark 5 is made in the outside face 2e of the ply 2.

Both in the variant of FIG. 1 and in the variant of FIG. 2, the ribbon 4 overlies the watermark 5 in part only.

The partial overlap between the ribbon 4 and the watermark 5 serves to distinguish two zones 7 and 8 of the watermark 5, the first zone corresponding to the portion of the watermark 5 that does not overlie the ribbon 4, and the second zone corresponding to the portion of the watermark 5 that does overlie the ribbon 4.

Observation in transmitted light of the two zones 7 and 8 as formed in this way reveals a difference in color and/or contrast between the portions of the watermark 5 respectively occupying these two zones 7 and 8.

FIG. 4 shows another example of a sheet 1 made in accordance with the invention.

In this example, the fiber substrate 6 of the sheet has a dark watermark 5 and a color ribbon 4, e.g. a blue ribbon, that overlies the watermark in part.

When the overlying watermark 5 and ribbon 4 are observed, a difference in contrast and/or color can be seen between the portions of the watermark 5 that are present in the zones 7 and 8.

The presence of the colored ribbon 4 gives rise to variation in the perception of the watermark 5 in the zone 8, which variation can be determined beforehand.

Furthermore, since the watermark 5 is made entirely in the fiber substrate 6, the patterns present in the watermark 5 must match exactly when the interface between the zones 7 and 8 is observed, and must present continuity. These patterns comprise for example lines 7a that extend transversely to the longitudinal direction of the ribbon.

In FIG. 5, the ribbon 4 is inserted in a single ply 9. The watermark comprises pale zones 10 as a result of reduced thickness and dark zones 11 as a result of increased thickness. The dark zones 11 overlying the ribbon 4 are referenced 11b and those that do not overlie the ribbon 4 are referenced 11a.

The pale zones 10 overlying the ribbon 4 are referenced 10a and the others are referenced 10b.

Although the zones 10a and 10b or 11a and lib are identical in thickness, they can be distinguished when observed because of the presence of the ribbon 4 under the portions 10b and 11b of the watermark.

For a printer, it would be very difficult to use a transparentizing ink to make a portion that corresponds to the portion of the watermark 5 that is observable in the zone 8, and another portion using a darker ink to correspond to the portion of the watermark 5 that is observable in the zone 7, and to put those portions exactly in register with each other so as to achieve continuity between the zones 7 and 8 when the watermark 5 is observed.

### EXAMPLE 1

Consideration is given to using a cylinder mold machine for making a watermark security sheet including a paper security ribbon of blue hue and provided with flakes printed in an invisible fluorescent ink.

### Fabricating Security Ribbons of the Invention:

A sheet of blue paper is fabricated on a Foudrinier papermaking machine. The blue hue is obtained by adding blue pigments to the fiber suspension before said sheet is formed and using the traditional method for fabricating colored sheets. The flakes printed with a fluorescent ink are added to the aqueous suspension of refined cellulose fibers of the order of 30°SR, the fiber mat containing the seeded flakes is pressed and dried. Once dried, the resulting sheet presents a weight of 45 g/m².

This produces a blue sheet including seeded invisible fluorescent flakes that are distributed uniformly in three dimensions, which sheet is then calendared, photogravure-coated on both faces with Mowilith DC adhesive at 5 g/m² per face, and then cut into ribbons having a width of 1.5 cm. The ribbons are reeled.

### Fabrication of a Watermark Security Sheet Including a Paper Ribbon of the Invention:

During fabrication of said watermark fiber substrate on the cylinder mold, said security ribbons are embedded by being introduced into the vat that contains the cylinder mold. The position at which said paper ribbon is introduced along the width of the papermaking machine is determined so that said paper ribbon overlies the watermark in said fiber substrate in part only.

After draining, pressing, and then drying the assembly comprising the substrate and the ribbon, a security sheet of the invention is obtained, e.g. as shown in face view in FIG. 4.

The security of the resulting security sheet is improved since, as explained above when described in FIG. 4, the patterns of the watermark present continuity at the interface between the watermark zones that are with and without the ribbon, while nevertheless having a different hue due to the color of said ribbon.

The term “comprising a” is synonymous with “comprising at least one”.

1-28. (canceled)

29. A sheet comprising a fiber substrate including at least one watermark and having at least partially incorporated therein a ribbon that is narrower than the substrate and that overlies the watermark in part.

30. A sheet according to claim 29, the ribbon being totally incorporated in the fiber substrate.

31. A sheet according to claim 29, the ribbon being partially incorporated in the fiber substrate.

32. A sheet according to claim 29, the ribbon being fibrous.

33. A sheet according to claim 29, the ribbon having no watermark.

34. A sheet according to claim 29, the ribbon having optical properties that are different from those of the substrate.

35. A sheet according to claim 29, the ribbon and the fiber substrate presenting a color difference ΔE greater than or equal to 0.2.

36. A sheet according to claim 29, the ribbon including a conventional ink or a security ink.

37. A sheet according to claim 29, the ribbon including a fluorescent agent.

38. A sheet according to claim 29, the watermark being a pale watermark.

39. A sheet according to claim 29, the watermark being a screened watermark.

40. A sheet according to claim 29, the ribbon including at least one adhesive.

41. A sheet according to claim 40, the adhesive including a heat-sealing agent.

42. A sheet according to claim 29, the ribbon extending between two opposite edges of the sheet.

43. A sheet according to claim 29, the weight of the ribbon lying in the range 5 g/m² to 100 g/m².

44. A sheet according to claim 29, the ribbon having a width lying in the range 2 mm to 60 mm.

45. A sheet according to claim 29, the ribbon having a thickness lying in the range 10 μm to 150 μm.

46. A sheet according to claim 29, the ribbon comprising cellulose fibers.

47. A sheet according to claim 29, the fiber substrate comprising cellulose fibers.

48. A sheet according to claim 29, the fiber substrate and the ribbon comprising fibers of the same kind.

49. A sheet according to claim 29, the ribbon including at least one security element selected from: tracers, nanometric tracers; security fibers, fibers that are metallic, magnetic, or absorbent or excitable in the ultraviolet, the visible, the infrared, or in the near infrared; flat security elements selected from the group consisting of flakes, pigments, clumps of pigments, and pigments that are absorbent or excitable under laser illumination or in ultraviolet, visible, infrared, or near infrared illumination; and security threads including an at least partial coating that is metallic, metal-plated, iridescent, or magnetic, chemical or biochemical reagents for combating falsification, and/or for authentication, and/or for identification, optically variable elements, holograms, liquid crystals, iridescent pigments, mirror-effect structures, dielectric layers; and combinations thereof.

50. A sheet according to claim 29, the watermark including a portion that extends continuously between two regions of the substrate that respectively overlie and do not overlie the ribbon.

51. A sheet according to claim 29, differences of color and/or contrast being observable to the naked eye between the zones of the watermark that overlie and that do not overlie the ribbon.

52. A sheet according to claim 29, the ribbon being disposed relative to the watermark in such a manner that portions of the watermark that do not overlie the ribbon exist on both sides of the ribbon.

53. A sheet according to claim 29, the ribbon being disposed relative to the watermark in such a manner that the portion of the watermark that does not overlie the ribbon exists on only one side of the ribbon.

54. A security document including a sheet as defined in claim 29.

55. An article for authentication including a sheet as defined in claim 29, the article being selected from: a safety label; packaging, packaging for medication, or for food, or for cosmetics or perfumes, or for electronic components, or for spare parts; a sheet used in the medical or hospital fields, a paper used for making sterilization packages; and art paper.

56. A method of authenticating a sheet as defined in claim 29, the method comprising observing the sheet in transmitted light, and in reaching a conclusion about its authenticity at least as a function of a difference of appearance between a region of the watermark that does not overlie the ribbon and a region that does overlie the ribbon.
